(19) United States
(12) Patent Application Publication
(10) Pub. No.: US 2025/0108524 A1
(43) Pub. Date: Apr. 3, 2025

(54) QUADRUPED ROBOT PROTECTION APPARATUS AND QUADRUPED ROBOT

(71) Applicant: HangZhou YuShu TECHNOLOGY CO., LTD., Hangzhou (CN)

(72) Inventor: Xingxing WANG, Hangzhou (CN)

(21) Appl. No.: 18/832,662

(22) PCT Filed: Dec. 14, 2022
(86) PCT No.: PCT/CN2022/139089

§ 371 Date: Jul. 24, 2024

(30) Foreign Application Priority Data
Jan. 28, 2022 (CN) 202220243448.6

(51) Int. Cl. B25J 19/00; B62D 57/032

(52) U.S. Cl. CPC B25J 19/0075; B62D 57/032

(57) ABSTRACT

A quadruped robot includes a quadruped robot body, an inflatable sleeve, and an air pump, where the inflatable sleeve covers the outer surface of the quadruped robot body; the air pump is configure to provide continuous air flow for the inflatable sleeve; the inflatable sleeve includes an air inlet of the inflatable sleeve and an air outlet of the inflatable sleeve, and an air flow rate of the air inlet of the inflatable sleeve is greater than an air flow rate of the air outlet of the inflatable sleeve; and the inflatable sleeve, after being inflated, forms an airbag covering the quadruped robot body. The exterior of the quadruped robot body is covered with the inflatable sleeve that, when being in an inflatable state, acts as a buffer layer of the quadruped robot to effectively protect the quadruped robot body from an excessively large external impact.

### TECHNICAL FIELD

The utility model relates to the technical field of quadruped robots, and in particular, to a quadruped robot protection apparatus and a quadruped robot.

### BACKGROUND ART

Currently, most of the manufacturing materials of a quadruped robot are hard materials such as metal or plastic, and the quadruped robot body is prone to knock damage. Moreover, since the movement speed of the quadruped robot is fast, when an operator lacks experience or operates it improperly, the quadruped robot is more likely to hit surrounding people or things, causing a potential safety hazard.

Furthermore, the outer surface of the quadruped robot is mostly made of metal or hard plastic, making it hard to adapt to diversified demands of consumers for the product appearance, and the appearance of the existing quadruped robot is not easy to change once it is molded, thereby affecting the user experience, which is not favorable to promotion.

In addition, the quadruped robot may generate much heat during operation, and in case of natural heat dissipation, the heat is dissipated slowly with low efficiency.

### Summary

[symbol]

### Technical Problem

[symbol]

### Solution of the Problem

[symbol]

### Technical Solution

[symbol]

In order to overcome the defects in the prior art, a first object of the utility model to provide a quadruped robot protection apparatus provided with an inflatable sleeve, where the inflatable sleeve may cover a quadruped robot body and thus may act as a buffer layer of a quadruped robot to effectively protect the quadruped robot body from an excessively large external impact, thereby protecting internal parts of the quadruped robot; moreover, due to the existence of the buffer layer, even if the quadruped robot hits a surrounding person or thing due to the lack of experience or improper operation of an operator of the quadruped robot, there is substantially no injury or damage caused to the person or thing, achieving an effective protection function.

A second object of the utility model to provide a quadruped robot protection apparatus provided with an inflatable sleeve with an appearance easy to design and change, where the inflatable sleeve can be easily designed into various appearances according to user demands, and an appearance of a quadruped robot may vary by sleeving the quadruped robot with inflatable sleeves of different appearances, increasing the fun in use of the quadruped robot and enriching application scenarios of the quadruped robot, leading to good user experience and facilitating the promotion of the use of the quadruped robot.

A third object of the utility model to provide a quadruped robot protection apparatus equipped with an inflatable sleeve capable of covering a quadruped robot body, where an air pump may be configured to continuously inflate the inflatable sleeve, so that there is continuous high-speed air flow in the inflatable sleeve, forming continuous low-temperature air flow between the inflatable sleeve and the quadruped robot body, which can take away heat generated by the quadruped robot body, thereby effectively improving the heat dissipation performance of the quadruped robot.

A fourth object of the utility model to provide a quadruped robot having a good protective effect and capable of protecting people or things around the quadruped robot.

In order to achieve one of the above objects, a first technical solution of the utility model is as follows:
A quadruped robot protection apparatus includes an inflatable sleeve and an air pump, where the inflatable sleeve may cover the outer surface of a quadruped robot body.

The air pump is configured to provide continuous air flow for the inflatable sleeve.

The inflatable sleeve includes an air inlet of the inflatable sleeve and an air outlet of the inflatable sleeve, and an air flow rate of the air inlet of the inflatable sleeve is greater than an air flow rate of the air outlet of the inflatable sleeve.

The inflatable sleeve, after being inflated, may form a stable air cavity capable of partially or completely covering the quadruped robot body.

Through constant exploration and tests, the utility model provides a quadruped robot protection apparatus. First, the exterior of the quadruped robot body may be covered with the inflatable sleeve that, when being in an inflated state, acts as a buffer layer of the quadruped robot to effectively protect the quadruped robot body from an excessively large external impact, thereby protecting internal parts of the quadruped robot; moreover, due to the existence of the buffer layer, even if the quadruped robot hits a surrounding person or thing due to the lack of experience or improper operation of an operator of the quadruped robot, there is substantially no injury or damage caused to the person or thing, achieving an effective protection function. As such, the application scenarios for the quadruped robot may be enriched significantly, for example, it can be safely used in an environment where children are present.

Moreover, the inflatable sleeve of the utility model may fit with the quadruped robot body, and the air pump is configured to continuously inflate the inflatable sleeve to form continuous high-speed air flow inside the inflatable sleeve, so that the heat generated by the quadruped robot body can be effectively taken away, thereby effectively improving the heat dissipation performance of the quadruped robot.

Furthermore, the inflatable sleeve of the utility model has an appearance easy to design and change, where an appearance of a quadruped robot may vary by sleeving the quadruped robot with inflatable sleeves of different appearances, increasing the fun in use of the quadruped robot and enriching application scenarios of the quadruped robot.

As a preferable technical solution:
The air pump is disposed at an abdomen of the quadruped robot body, the air pump includes an air inlet of the air pump and an air outlet of the air pump, the air inlet of the air pump is communicated with the exterior of the inflatable sleeve, and the air outlet of the air pump is connected to the air inlet of the inflatable sleeve in a sealed manner.

As a preferable technical solution:
The inflatable sleeve completely covers the outer surface of the quadruped robot body, the quadruped robot body includes a leg, and the air outlet of the inflatable sleeve is disposed at the leg or at any surface position on the inflatable sleeve.

In some examples, the air outlet of the inflatable sleeve is disposed at the leg of the quadruped robot body, making a circulation path of air flow around the quadruped robot body longer, thereby achieving a better heat dissipation effect.

As a preferable technical solution:

The air outlets of the inflatable sleeve are microscopic apertures distributed on the surface of the inflatable sleeve.

The inflatable sleeve is provided with a hairy structure on the outer surface thereof, providing a better hand feeling and making it more bionic, thereby improving the user experience.

As a preferable technical solution:

The inflatable sleeve is provided with a sealable opening for placing the quadruped robot body.

As a preferable technical solution:

The inflatable sleeve is in the shape of one of a cat, a tiger, a dog, a horse, a cow, a panda, and a rabbit after being inflated. The appearance of the inflatable sleeve is designed into the shapes of a variety of specific quadrupeds, increasing the fun in the use of the quadruped robot.

In order to achieve one of the above objects, a second technical solution of the utility model is as follows:

A quadruped robot protection apparatus includes an inflatable sleeve capable of partially or completely covering the outer surface of a quadruped robot body.

The inflatable sleeve, after being inflated, forms an air cavity covering the quadruped robot body.

Through constant exploration and tests, the utility model provides a quadruped robot protection apparatus, where the exterior of the quadruped robot body first may be covered with the inflatable sleeve that, when being in an inflated state, acts as a buffer layer of the quadruped robot to effectively protect the quadruped robot body from an excessively large external impact, thereby protecting internal parts of the quadruped robot; moreover, due to the existence of the buffer layer, even if the quadruped robot hits a surrounding person or thing due to the lack of experience or improper operation of an operator of the quadruped robot, there is no injury or damage caused to the person or thing, achieving an effective protection function and eliminating a potential safety hazard. As such, the application scenarios for the quadruped robot may be enriched significantly, for example, it can be safely used in an environment where children are present.

Furthermore, the inflatable sleeve of the utility model is manufactured from a polyolefin copolymer, polyamide, polyethylene, animal leather, resin, or rubber, and has an appearance easy to design and change, where an appearance of a quadruped robot may vary by sleeving the quadruped robot with inflatable sleeves of different appearances, increasing the fun in use of the quadruped robot and enriching application scenarios of the quadruped robot.

As a preferable technical solution:

The inflatable sleeve is provided with several compartments independent from each other, so as to avoid an impact on the use of a remaining part of the inflatable sleeve after part of the inflatable sleeve is damaged, thereby effectively prolonging the service life of the inflatable sleeve.

Alternatively, the inflatable sleeve is assembled from several inflatable bodies, facilitating the assembly of various appearances and shapes, and facilitating the replacement of a damaged inflatable body, thereby effectively reducing the manufacturing cost and use cost of the inflatable sleeve.

An assembly method may be gluing, sewing, zipper connection, or Velcro connection.

Alternatively, the inflatable sleeve is a single-layer or multilayer structure, with at least one layer thereof being an airbag structure capable of sealing off air. By adding a protective structure, the service life of the inflatable sleeve may be effectively prolonged, and at the same time, various appearances may be set up easily.

As a preferable technical solution:

The compartment or inflatable body is a disposable airbag or is provided with an inflation port, and is manufactured from a polyolefin copolymer, polyamide, polyethylene, animal leather, resin, or rubber.

The multilayer structure includes a protective layer on the outermost side, a skin layer for accommodating air, and a contact layer for abutting on the quadruped robot body.

The protective layer, the skin layer, and the contact layer are sequentially stacked together.

In some examples, the skin layer is manufactured from a polyolefin copolymer, polyamide, polyethylene, animal leather, resin, or rubber.

The protective layer is manufactured from plastic, fabric, or rubber. The contact layer may be a thin film manufactured from a polyolefin copolymer, polyamide, polyethylene, animal leather, resin, or rubber.

In order to achieve one of the above objects, a third technical solution of the utility model is as follows:

A quadruped robot includes a quadruped robot body, and a quadruped robot protection apparatus as described above.

Beneficial Effects of the Utility Model

Beneficial Effects

The utility model provides a quadruped robot protection apparatus. Firstly, the exterior of the quadruped robot body is covered with the inflatable sleeve that, when being in an inflated state, acts as a buffer layer of the quadruped robot to effectively protect the quadruped robot body from an excessively large external impact, thereby protecting internal parts of the quadruped robot; moreover, due to the existence of the buffer layer, even if the quadruped robot hits a surrounding person or thing due to the lack of experience or improper operation of an operator of the quadruped robot, there is no injury or damage caused to the person or thing, achieving an effective protection function. As such, the application scenarios for the quadruped robot may be enriched significantly, for example, it can be safely used in an environment where children are present.

Secondly, the air pump is configured to continuously inflate the inflatable sleeve to form continuous high-speed air flow between the inflatable sleeve and the quadruped robot body, so that the heat generated by the quadruped robot body can be effectively taken away, thereby effectively improving the heat dissipation performance of the quadruped robot.

Lastly, the inflatable sleeve has an appearance easy to design and change, where an appearance of a quadruped robot may vary by sleeving the quadruped robot with inflatable sleeves of different appearances, increasing the fun in use of the quadruped robot and enriching application scenarios of the quadruped robot.

### BRIEF DESCRIPTION OF THE DRAWINGS

Description of the Drawings

FIG. 1 is a schematic diagram of a specific structure of the utility model;

FIG. 2 is an axial side diagram of the utility model;

FIG. 3 is a side view of the utility model; and

FIG. 4 is a schematic diagram of a quadruped robot body of the utility model.

In the drawings: 1, quadruped robot body; 2, inflatable sleeve; 3, air pump; 4, air inlet of the air pump; 5, air outlet of the inflatable sleeve.

### DETAILED DESCRIPTION OF EMBODIMENTS

Embodiments of the Utility Model The utility model is further described below in conjunction with the accompanying drawings and specific embodiments. It should be noted that, in case of no conflicts, the embodiments or technical features described below may be combined to form new embodiments.

Unless otherwise defined, all technical and scientific terms used herein have the same meanings as those commonly understood by those skilled in the art to which the utility model belongs. The terms used herein are merely for the purpose of describing specific embodiments, but are not intended to limit the utility model.

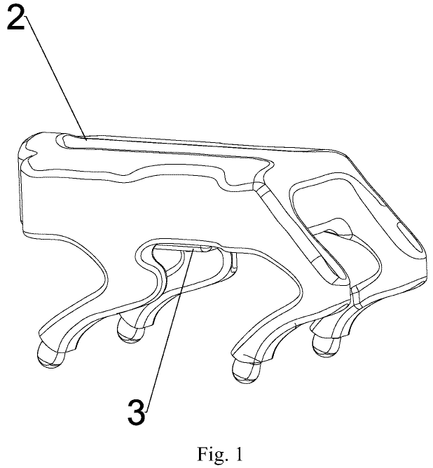

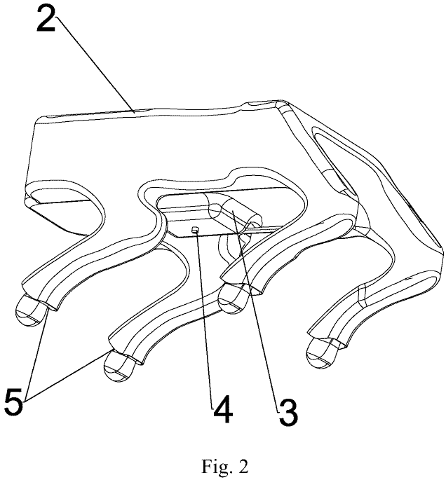

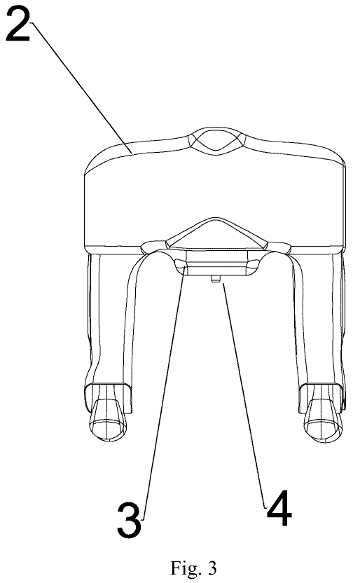

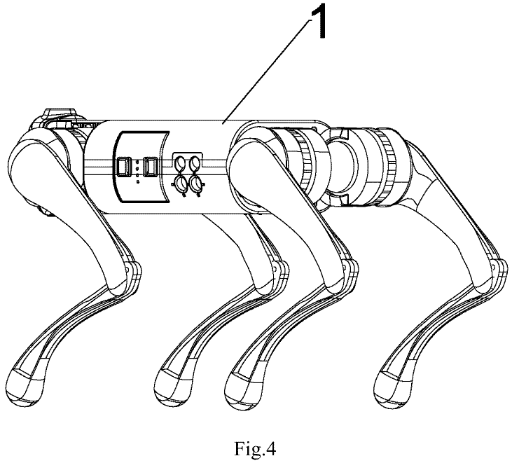

An optimal embodiment of a protection apparatus of the utility model as shown in FIGS. 1, 2, 3, and 4:

A quadruped robot protection apparatus includes an inflatable sleeve 2 and an air pump 3, where the inflatable sleeve 2 may cover the outer surface of a quadruped robot body 1.

The air pump 3 is configured to provide continuous air flow for the inflatable sleeve 2.

The inflatable sleeve 2 includes an air inlet of the inflatable sleeve 2 and an air outlet 5 of the inflatable sleeve, and an air flow rate of the air inlet of the inflatable sleeve 2 is greater than an air flow rate of the air outlet 5 of the inflatable sleeve.

The inflatable sleeve 2, after being inflated, may form a stable air cavity capable of partially or completely covering the quadruped robot body 1.

The utility model provides a quadruped robot protection apparatus. Firstly, the exterior of the quadruped robot body 1 is covered with the inflatable sleeve 2 that, when being in an inflated state, acts as a buffer layer of the quadruped robot to effectively protect the quadruped robot body 1 from an excessively large external impact, thereby protecting internal parts of the quadruped robot; moreover, due to the existence of the buffer layer, even if the quadruped robot hits a surrounding person or thing due to the lack of experience or improper operation of an operator of the quadruped robot, there is no injury or damage caused to the person or thing, achieving an effective protection function. As such, the application scenarios for the quadruped robot may be enriched significantly, for example, it can be safely used in an environment where children are present.

Secondly, the air pump 3 is configured to continuously inflate the inflatable sleeve 2 to form continuous high-speed air flow between the inflatable sleeve 2 and the quadruped robot body 1, so that the heat generated by the quadruped robot body 1 can be effectively taken away, thereby effectively improving the heat dissipation performance of the quadruped robot.

Lastly, the inflatable sleeve 2 has an appearance easy to design and change, where an appearance of a quadruped robot may vary by sleeving the quadruped robot with inflatable sleeves 2 of different appearances, increasing the fun in use of the quadruped robot and enriching application scenarios of the quadruped robot.

A specific embodiment of an inflatable structure of the utility model:

The air pump 3 is disposed at an abdomen of the quadruped robot body 1, the air pump 3 includes an air inlet of the air pump 3 and an air outlet 4 of the air pump, the air inlet of the air pump 3 is communicated with the exterior of the inflatable sleeve 2, and the air outlet 4 of the air pump is connected to the air inlet of the inflatable sleeve 2 in a sealed manner.

A specific embodiment of application of the utility model in heat dissipation:

The inflatable sleeve 2 completely covers the outer surface of the quadruped robot body 1, the quadruped robot body 1 includes a leg, and the air outlet 5 of the inflatable sleeve is disposed at the leg. The air outlet of the inflatable sleeve 2 is disposed at the leg of the quadruped robot body 1, making a circulation path of air flow around the quadruped robot body 1 longer, thereby achieving a better heat dissipation effect.

A specific embodiment of the shape of the inflatable sleeve 2 of the utility model:

The inflatable sleeve 2 is manufactured from a polyolefin copolymer, polyamide, polyethylene, animal leather, resin, or rubber, and is in the shape of one of a cat, a tiger, a dog, a horse, and a cow after being inflated. The appearance of the inflatable sleeve 2 is designed into the shapes of a variety of specific quadrupeds, increasing the fun in the use of the quadruped robot.

Another embodiment of the protection apparatus of the utility model:

A quadruped robot protection apparatus includes an inflatable sleeve capable of partially or completely covering the outer surface of a quadruped robot body, where the inflatable sleeve, after being inflated, forms an air cavity covering the quadruped robot body.

A first specific embodiment of an inflatable sleeve structure of the utility model:

The inflatable sleeve is provided with several compartments independent from each other, so as to avoid an impact on the use of a remaining part of the inflatable sleeve after part of the inflatable sleeve is damaged, thereby effectively prolonging the service life of the inflatable sleeve.

The compartment is a disposable airbag or is provided with an inflation port, and is manufactured from a polyolefin copolymer, polyamide, polyethylene, animal leather, resin, or rubber.

A second specific embodiment of an inflatable sleeve structure of the utility model:

The inflatable sleeve is assembled from several inflatable bodies, facilitating the assembly of various appearances and shapes, and facilitating the replacement of a damaged inflatable body, thereby effectively reducing the manufacturing cost and use cost of the inflatable sleeve.

The inflatable body is a disposable airbag or is provided with an inflation port, and is manufactured from a polyolefin copolymer, polyamide, polyethylene, animal leather, resin, or rubber.

An assembly method may be gluing, sewing, zipper connection, or Velcro connection.

A third specific embodiment of an inflatable sleeve structure of the utility model:

The inflatable sleeve is a single-layer or multilayer structure, with at least one layer thereof being an airbag structure capable of sealing off air. By adding a protective structure, the service life of the inflatable sleeve may be effectively prolonged, and at the same time, various appearances may be set up easily.

A specific embodiment of the utility model:

The multilayer structure includes a protective layer on the outermost side, a skin layer for accommodating air, and a contact layer for abutting on the quadruped robot body.

The skin layer is manufactured from a polyolefin copolymer, polyamide, polyethylene, animal leather, resin, or rubber.

The protective layer is manufactured from plastic, fabric, or rubber.

The contact layer may be a thin film manufactured from a polyolefin copolymer, polyamide, polyethylene, animal leather, resin, or rubber.

An embodiment of application of the protection apparatus of the utility model:

A quadruped robot includes a quadruped robot body, an inflatable sleeve, and an air pump, where the inflatable sleeve covers the outer surface of the quadruped robot body; the air pump is configured to provide continuous air flow for the inflatable sleeve; the inflatable sleeve includes an air inlet of the inflatable sleeve and an air outlet of the inflatable sleeve, and an air flow rate of the air inlet of the inflatable sleeve is greater than an air flow rate of the air outlet of the inflatable sleeve; and the inflatable sleeve may fit with the quadruped robot body after being inflated, so as to effectively protect the quadruped robot and the external environment, and at the same time conduct and dissipate heat of the quadruped robot timely.

The above embodiments are merely preferable embodiments of the utility model, and the scope of protection of the utility model is not limited thereto. Any non-substantive changes or substitutions made by those skilled in the art on the basis of the utility model fall within the scope of protection claimed by the utility model. AMENDMENTS TO THE CLAIMS

1. A quadruped robot protection apparatus, comprising an inflatable sleeve (2) and an air pump (3), wherein the inflatable sleeve (2) may cover the outer surface of a quadruped robot body (1);
the air pump (3) is configured to provide continuous air flow for the inflatable sleeve (2);
the inflatable sleeve (2)-comprises an air inlet of the inflatable sleeve and an air outlet (5) of the inflatable sleeve, and an air flow rate of the air inlet of the inflatable sleeve is greater than an air flow rate of the air outlet (5) of the inflatable sleeve; and
the inflatable sleeve-(2), after being inflated, may form a stable air cavity capable of partially or completely covering the quadruped robot body (1).

2. The quadruped robot protection apparatus according to claim 1, wherein the air pump (3) is disposed at an abdomen of the quadruped robot body (1), the air pump (3)-comprises an air inlet (4) of the air pump and an air outlet of the air pump, the air inlet (4) of the air pump is communicated with the exterior of the inflatable sleeve (2), and the air outlet of the air pump (3) is connected to the air inlet of the inflatable sleeve in a sealed manner.

3. The quadruped robot protection apparatus according to claim 2, wherein the inflatable sleeve (2) completely covers the outer surface of the quadruped robot body (1), the quadruped robot body (1) comprises a leg, and the air outlet (5) of the inflatable sleeve is disposed at the leg or at any surface position on the inflatable sleeve (2).

4. The quadruped robot protection apparatus according to claim 3, wherein the air outlets (5) of the inflatable sleeve (2) are microscopic apertures distributed on the surface of the inflatable sleeve (2); and
the inflatable sleeve (2)-is provided with a hairy structure on the outer surface thereof.

5. The quadruped robot protection apparatus according to claim 4, wherein the inflatable sleeve (2)-is provided with a sealable opening for placing the quadruped robot body (l).

6. The quadruped robot protection apparatus according to any one of claims 1-5 claim 1, wherein the inflatable sleeve (2) is in the shape of one of a cat, a tiger, a dog, a horse, a cow, a panda, and a rabbit after being inflated.

7. A quadruped robot protection apparatus, comprising an inflatable sleeve capable of partially or completely covering the outer surface of a quadruped robot body, wherein the inflatable sleeve, after being inflated, forms an air cavity covering the quadruped robot body.

8. The quadruped robot protection apparatus according to claim 7, wherein the inflatable sleeve is provided with several compartments independent from each other;
or the inflatable sleeve is assembled from several inflatable bodies; or the inflatable sleeve is a single-layer or multilayer structure, with at least one layer thereof being an airbag structure capable of sealing off air.

9. The quadruped robot protection apparatus according to claim 8, wherein the compartment or inflatable body is a disposable airbag or is provided with an inflation port, and is manufactured from a polyolefin copolymer, polyamide, polyethylene, animal leather, resin, or rubber;
the multilayer structure comprises a protective layer on the outermost side, a skin layer for accommodating air, and a contact layer for abutting on the quadruped robot body; and
the protective layer, the skin layer, and the contact layer are sequentially stacked together.

10. A quadruped robot, comprising:
a quadruped robot body, and the quadruped robot protection apparatus according to any one of claims 1 9 claim 1.
